(19) United States
(12) Patent Application Publication
(10) Pub. No.: US 2026/0037446 A1
(43) Pub. Date: Feb. 5, 2026

(54) Cache Coherency

(71) Applicant: Mellanox Technologies, Ltd., Yokneam (IL)

(72) Inventors: Yorai Itzhak Zack, Kiryat Ata (IL); Gal Shalom, Givat-Avni (IL); Aviad Shaul Yehezkel, Yokneam Ilit (IL); Eliav Bar-Ilan, Or Akiva (IL); Idan Zach, Givat Ela (IL); Oren Duer, Kohav Yair (IL); Vishwanath Venkatesan, Austin, TX (US); Omri Kahalon, Tel Aviv (IL)

(21) Appl. No.: 18/789,750

(22) Filed: Jul. 31, 2024

(51) Int. Cl. G06F 12/0817

(52) U.S. Cl. CPC G06F 12/0828; G06F 2212/621

(57) ABSTRACT

In one embodiment, a device includes a host interface to be connected to a host device via a data communication bus; and at least one processing core to expose a device emulation function to the host device, maintain a peripheral device cache, invalidate a cache entry in peripheral device cache in response to receiving a cache invalidation from a backend function, execute a translation function to translate between a format of the device emulation function and a format of the backend function, receive the cache invalidation from the backend function, translate the cache invalidation to the format of the device emulation function, and 10 provide the translated cache invalidation function to the device emulation function being executed by a processor of the host device.

### FIELD OF THE DISCLOSURE

The present disclosure relates to computer systems, and in particular, but not exclusively to, cache coherency with device emulation.

### BACKGROUND

A host device may be connected to a peripheral device such as a data processing unit (DPU), which is connected to a network. The DPU may include multiple processing cores and a network interface controller (NIC). The DPU and host device may be connected via a suitable data communication bus operating according to any suitable protocol, for example, Peripheral Component Interconnect Express (PCIe). Without using device emulation, the NIC may expose a physical function (PF) on the host device side of the PCIe. The PF allows the host device to communicate with the network without the host device knowing what is occurring in the NIC.

With device emulation, the NIC exposes a virtual device emulation function (e.g., VirtioNet) to the host device, which allows the host device to communicate with the network. A translation layer or function is also used to translate between the format of the device emulation function and the format of the NIC. In this manner, in some implementations the NIC may be replaced with a new, different type, of NIC, and the host device may still communicate with the network via the new NIC using a suitable translation layer and optionally suitable device emulation function.

Device emulation may be used to allow a virtual machine (VM) running on the host device to communicate with the network. Device emulation may be implemented using different methods. Some implementations provide low latency, but the device emulation functions are hardware specific. Other implementations are hardware independent but suffer from latency issues, for example, when the translation layer is disposed in the host device.

Some device emulation implementations provide hardware independent functionality with improved latency by running the translation layer on the DPU. For example, the DPU runs a VirtioNet to NetFunction translation layer, while VirtioNet is run by the hypervisor and each VM run by the hypervisor.

Another example of device emulation is file system device emulation, in which the host device (e.g., a VM running on the host device) accesses one or more file systems using a file system device emulation function (e.g., VirtioFS) running on the VM. The DPU may then run a translation function between the file system device emulation function and the file system. The VM may see a simple representation of the file system, while the logic to access the file system is implemented in the DPU. For example, the DPU emulates the file system by exposing VirtioFS to the host device, the host device issues input-output (I/O) requests to VirtioFS, and the DPU transfers data using VirtQueues.

### OVERVIEW

There is provided in accordance with an embodiment of the present disclosure, a device, including a host interface to be connected to a host device via a data communication bus, and at least one processing core to expose a device emulation function to the host device, maintain a peripheral device cache, invalidate a cache entry in peripheral device cache in response to receiving a cache invalidation from a backend function, execute a translation function to translate between a format of the device emulation function and a format of the backend function, receive the cache invalidation from the backend function, translate the cache invalidation to the format of the device emulation function, and provide the translated cache invalidation function to the device emulation function being executed by a processor of the host device.

Further in accordance with an embodiment of the present disclosure the device emulation function is a file system device emulation function, the backend function is a file system, and the translation function is to translate between a format of the file system device emulation function and a format of the file system.

Still further in accordance with an embodiment of the present disclosure the file system is a local file system, and is executed by the peripheral device.

Additionally in accordance with an embodiment of the present disclosure the device emulation function is a block storage system device emulation function, the backend function is a block storage system, and the translation function is to translate between a format of the block storage system device emulation function and a format of the block storage system.

Moreover, in accordance with an embodiment of the present disclosure the translation function is to provide the translated cache invalidation to a notification queue disposed on the host device.

Further in accordance with an embodiment of the present disclosure, the device includes a data processing unit (DPU) including the at least one processing core and a network interface controller (NIC).

There is also provided in accordance with another embodiment of the present disclosure, a system, including a host device and a peripheral device, the host device including a processor, the peripheral device including a host interface to be connected to a host device via a data communication bus, and at least one processing core to expose a device emulation function to the host device, maintain a peripheral device cache, and invalidate a cache entry in peripheral device cache in response to receiving a cache invalidation from a backend function, execute a translation function to translate between a format of the device emulation function and a format of the backend function, receive the cache invalidation from the backend function, translate the cache invalidation to the format of the device emulation function, and provide the translated cache invalidation to the device emulation function being executed by the processor of the host device.

Still further in accordance with an embodiment of the present disclosure the device emulation function is a file system device emulation function, the backend function is a file system, and the translation function is to translate between a format of the file system device emulation function and a format of the file system.

Additionally in accordance with an embodiment of the present disclosure the file system is a local file system, and is executed by the peripheral device.

Moreover, in accordance with an embodiment of the present disclosure the device emulation function is a block storage system device emulation function, the backend function is a block storage system, and the translation function is to translate between a format of the block storage system device emulation function and a format of the block storage system.

Further in accordance with an embodiment of the present disclosure the processor is to execute the device emulation function, the processor is to maintain a host cache, and the device emulation function is to receive the translated cache invalidation and provide a command to invalidate a cache entry in the host cache based on the received translated cache invalidation.

Still further in accordance with an embodiment of the present disclosure the translation function is to provide the translated cache invalidation to a notification queue disposed on the host device, and the device emulation function is to read the translated cache invalidation from the notification queue.

Additionally in accordance with an embodiment of the present disclosure the processor of the host device is to execute a hypervisor, and the hypervisor is to execute a virtual machine (VM), which is to execute the device emulation function.

Moreover, in accordance with an embodiment of the present disclosure the device emulation function is a file system device emulation function, the backend function is a file system, and the translation function is to translate between a format of the file system device emulation function and a format of the file system.

Further in accordance with an embodiment of the present disclosure the peripheral device includes a data processing unit (DPU), including the at least one processing core and a network interface controller (NIC).

There is also provided in accordance with still another embodiment of the present disclosure, a method, including exposing a device emulation function to a host device, maintaining a peripheral device cache, invalidating a cache entry in peripheral device cache in response to receiving a cache invalidation from a backend function, translating between a format of the device emulation function and a format of the backend function, receiving the cache invalidation from the backend function, translating the cache invalidation to the format of the device emulation function, and providing the translated cache invalidation to the device emulation function being executed by a processor of the host device.

Still further in accordance with an embodiment of the present disclosure the device emulation function is a file system device emulation function, the backend function is a file system, and the method further includes translating between a format of the file system device emulation function and a format of the file system.

Additionally in accordance with an embodiment of the present disclosure the device emulation function is a block storage system device emulation function, the backend function is a block storage system, and the method further includes translating between a format of the block storage system device emulation function and a format of the block storage system.

Moreover, in accordance with an embodiment of the present disclosure, the method includes executing the device emulation function in the host device, maintaining a host cache, receiving the translated cache invalidation, and providing a command to invalidate a cache entry in the host cache based on the received translated cache invalidation.

Further in accordance with an embodiment of the present disclosure, the method includes providing the translated cache invalidation to a notification queue disposed on the host device, and reading the translated cache invalidation from the notification queue.

### BRIEF DESCRIPTION OF THE DRAWINGS

The present disclosure will be understood from the following detailed description, taken in conjunction with the drawings in which:

FIG. 1 is a block diagram view of a computer system constructed and operative in accordance with an embodiment of the present disclosure;

FIG. 2 is a flowchart including steps in a method of operation of one or more processing cores in a peripheral device of the system of FIG. 1;

FIG. 3 is a block diagram view of the computer system of FIG. 1 illustrating cache invalidation; and

FIG. 4 is a flowchart including steps in a method of operation of a processor of a host device of the system of FIG. 1.

### DESCRIPTION OF EXAMPLE EMBODIMENTS

### Overview of Example Embodiments

A distributed file system generally guarantees user cache coherency so that when a user reads from the cache, the user is guaranteed that it reads the most up to data values. For example, one of the most common HPC File Systems is Lustre, a POSIX-compliant, distributed parallel file system designed for scalability, high-performance, and high-availability. Lustre runs on Linux-based operating systems and employs a client-server network architecture as a filesystem. The Lustre software stack includes different layers that handle file I/O operations, provide a smart locking mechanism that guarantees coherency on the client's cache, and distributes the file mechanism, among other features.

Cache coherency issues may occur when a file system is presented as a local device to the host device, but the file system backend is also part of a distributed file system that the host device is unaware of. A peripheral device is connected to the host device. A local driver of peripheral device running in the host device may store data in a local cache, and then that data may be updated by a different host (or different VM) on a remote server. A peripheral device of the host device expects that the local driver is the source of all the requests, therefore the peripheral device does not notify the host device about cache invalidation updates.

For example, in a system using device emulation such as where DPU-A exposes a file system (FS) device emulation function to a host device (e.g., to VM-A running on the host device), DPU-A may include a translation function to translate between the device emulation function and the file system. The host and/or VM-A may operate an FS cache, and the DPU-A may operate an FS cache. When the FS caches are not synchronized, if VM-B or another host accesses a file cached by VM-A, the cache of VM-A will not be up to date. For example, if VM-B updates file X, and sends a write request for file X to the FS backend, the FS backend should send an invalidation for file X to all the relevant caches so that file X is removed from the relevant caches (including the cache of VM-A). However, due to the virtualization of the file system, the invalidation for file X does not reach VM-A and therefore VM-A will not see the update as it thinks it has the latest version of file X in its cache. VM-A will not see the update until file X is removed from the cache for another reason, e.g., cache is full.

The current solution for an application that wants to use a coherent FS is to skip over the cache using O_DIRECT for example. However, this results in a performance hit as the cache is there for a reason, which is in order to improve performance.

Therefore, embodiments of the present disclosure address some of the above drawbacks by creating a channel from a peripheral device (e.g., DPU such as DPU-A) to a host device (e.g., to a VM, such as VM-A, running on the host device) to provide a cache invalidation received from a backend function (e.g., file system or block storage system) to the host device (e.g., to VM-A) to invalidate the cache maintained by the host device thereby providing improved performance of the host device and the various I/O mechanisms.

In some embodiments, a cache invalidation is received by a translation function running in the peripheral device from the backend function (e.g., file system client or block storage system). The backend function operates a system such as the file system or block storage system, or any suitable system. The translation function translates the cache invalidation from a format of the backend function (e.g., of the file system or block storage system) to a format of the device emulation function (e.g., VirtioFS) running on the host device. The translation function provides the translated cache invalidation to the device emulation function, for example, via a notification queue managed by the device emulation function, which is executed by the host device or by a hypervisor run by the host device. The device emulation function (e.g., running on a VM in the host device) may read the translated cache invalidation (e.g., from the queue) and invalidate the relevant cache entry in the host cache by sending a suitable command to a function managing the cache. The host device may acknowledge the cache invalidation. The channel may operate in synchronous or asynchronous mode, and the invalidation request may comply with the FUST_NOTIFY_INVAL_INODE and FUSE_NOTIFY_INVAL_ENTRY formats for example.

### SYSTEM DESCRIPTION

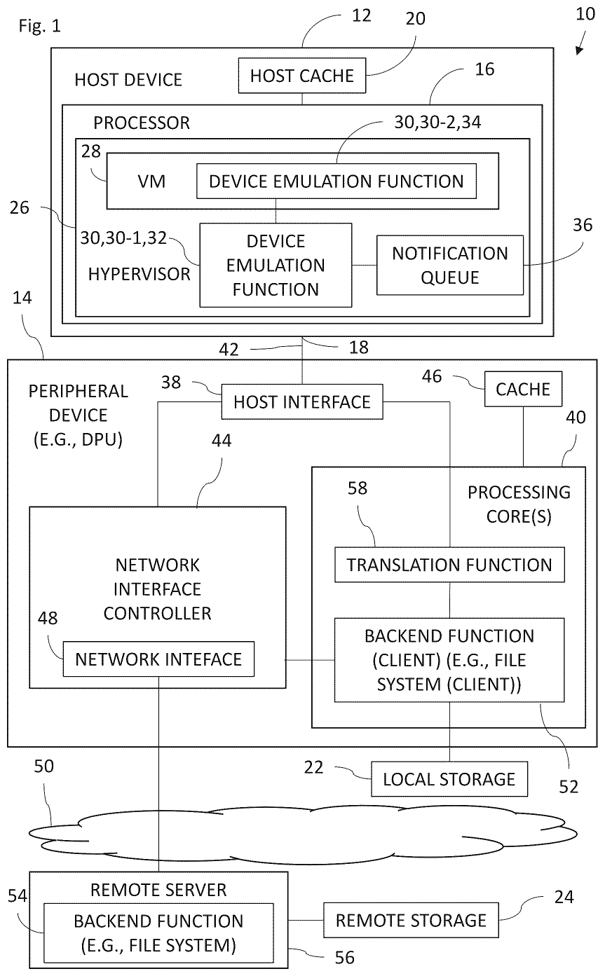

Reference is now made to FIG. 1, which is a block diagram view of a computer system 10 constructed and operative in accordance with an embodiment of the present disclosure. The system 10 includes a host device 12 and a peripheral device 14.

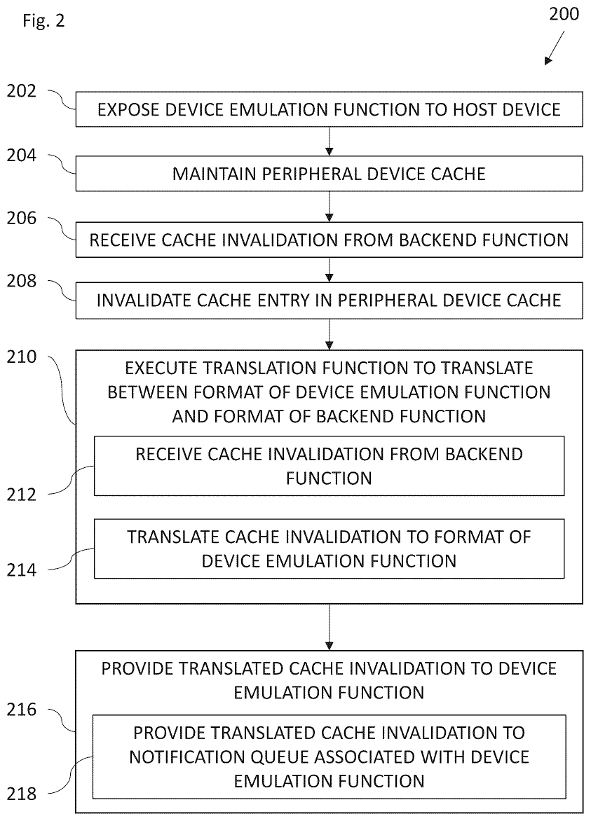

The host device 12 includes a processor 16, an interface 18 with the peripheral device 14, and a host cache 20. The host cache 20 is configured to store data used by the processor 16, for example, data read from local storage 22 or remote storage 24, described in more detail below. The processor 16 may be a general-purpose processor such as a central processing unit (CPU) or any suitable processing unit. In some embodiments, the processor 16 is configured to execute a hypervisor 26, which is configured to execute one or more virtual machines (VMs) 28. For the sake of simplicity, FIG. 1 shows a single VM 28. As will be described in more detail below, in order to enable device emulation, the peripheral device 14 may expose a device emulation function 30 to the host device 12. In some embodiments, the hypervisor 26 is configured to execute an instance 30-1 of device emulation function 30 (also referred herein as device emulation function 32), and each VM 28 is configured to execute its own instance 30-2 of device emulation function 30 (also reference herein as device emulation function 34), such that different device emulation functions 34 are executed by different VMs 28. The device emulation function 32 is configured to maintain a notification queue 36, described in more detail with reference to FIGS. 2-4. The notification queue may be any suitable queue used to queue notification messages and is not limited to any given protocol. The processor 16 and/or the VM 28 may execute a client program which reads data from, and/or writes data to, the local storage 22 and/or the remote storage 24 via the device emulation function 30. In some embodiments, device emulation function 30 is a file system device emulation function (e.g., VirtioFS) or a block storage system device emulation function (e.g., VirtioBLOCK), or any suitable device emulation function 30.

In practice, some or all of these functions of the processor 16 may be combined in a single physical component or, alternatively, implemented using multiple physical components. These physical components may comprise hard-wired or programmable devices, or a combination of the two. In some embodiments, at least some of the functions of the processor 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The peripheral device 14 includes a host interface 38, one or more processing cores 40 (e.g., one or more Reduced Instruction Set Computer (RISC) for example ARM cores commercially available from ARM Holding PLC, Cambridge, England, UK), and a peripheral device cache 46 for use by the processing cores 40, for example, to cache data read from local storage 22 and/or remote storage 24. The host interface 38 is configured to be connected to host device 12 via a data communication bus 42 using any suitable protocol such as PCIe. In some embodiments, the peripheral device 14 is, or includes, a data processing unit (DPU), which includes the host interface 38, the processing cores 40, and network interface controller (NIC) 44. The NIC 44 may include any suitable circuits, for example, but not limited to, a physical layer (PHY) chip (not shown) and a MAC chip (not shown). The NIC 44 may also include a network interface 48 including ports (not shown) to connect the peripheral device 14 to other devices over a network 50.

The processing core(s) 40 is configured to execute a backend function and/or a backend function (client) 52. When the processing core(s) 40 is configured to execute a backend function client 52, the client 52 communicates with another backend function 54 executed on a remote server 56. The backend function 54 may correspond to any suitable backend function, such as a file system (FS) or block storage system. For example, the backend function client 52 may be a file system client to communicate over network 50 with the backend function 54 (which is a remote file system), and the backend function 54 is configured to read data from, and write data to, remote storage 24.

When the processing core(s) 40 is configured to execute a backend function 52, the backend function 52 may correspond to any suitable backend function, such as a local file system (FS) or local block storage system. For example, the backend function 52 may be a local file system configured to read data from, and write data to, local storage 22.

The system 10 may include one or more local file systems and/or one or more remote file systems controlled via one or more remote servers. The client program executed by the processor 16 of the host device 12 may read data from, and/or write data to, virtual storage which may map to the local storage 22 and/or the remote storage 24 or any other storage medium local to peripheral device 14 or across network 50. The host device 12 (including the VM 28) does not have knowledge of the various physical storage mediums. The VM 28 “thinks” all the storage is local and “thinks” that all the storage is accessible via the device emulation function 34 run by VM 28. VM 28 reads and/or writes to storage via device emulation function 34 and does not have knowledge of the file system even if it is local or remote. The backend function (client) 52 determines where to store data (e.g. locally or remotely) and other storage parameters.

It should be noted that one or more other VMs 28 running on host device 12 or other host devices in system 10 may also share local storage 22 and/or remote storage 24, as applicable. An orchestrator (not shown) may determine how all the file storage is set up for system 10. The advantage of the above is that a system administrator of system 10 may enforce storage policies which are not visible to the host device 12 (and other host devices) or hypervisors in the system 10.

In some embodiments, the processing core(s) 40 may execute more than one backend function 52 (e.g., file systems with associated local storage devices) and/or more than one backend function client 52 (e.g., file system clients with associated remote storage devices), and the device emulation function 34 may communicate with the multiple backend function (client) s 52.

In some embodiments, the above functionality may be implemented on the host device 12 without using any VMs such that the device emulation function 30 is executed by the processor 16 without using a hypervisor, for example.

The processing core(s) 40 is also configured to execute a translation function 58 configured to translate between a format of the backend function (e.g., file system or block storage system) and a format of the device emulation function 30, as described in more detail with reference to FIG. 2.

In practice, some or all of these functions of the processing core(s) 40 may be combined in a single physical component or, alternatively, implemented using multiple physical components. These physical components may comprise hard-wired or programmable devices, or a combination of the two. In some embodiments, at least some of the functions of the processing core(s) 40 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

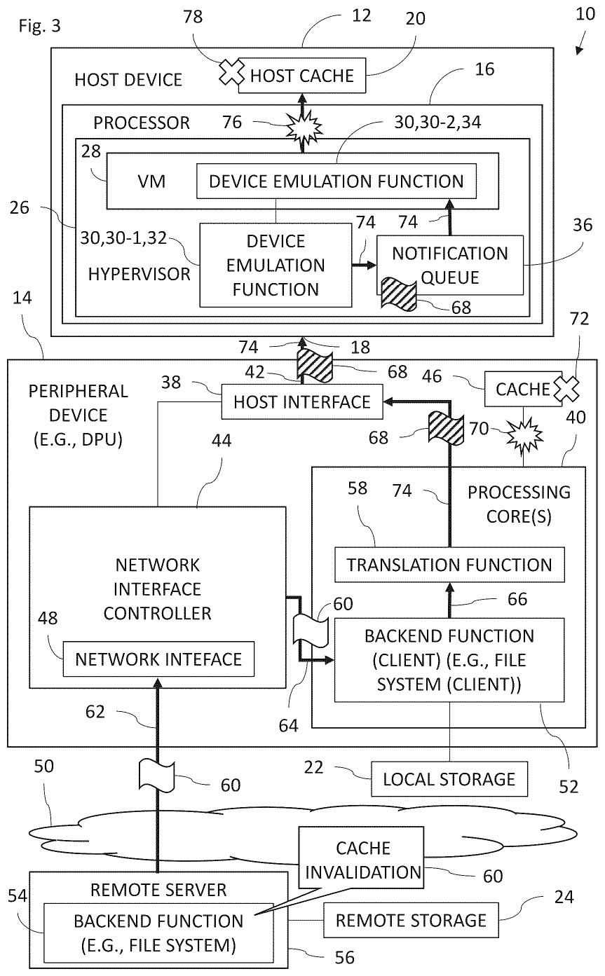

Reference is now made to FIGS. 2 and 3. FIG. 2 is a flowchart 200 including steps in a method of operation of one or more processing cores 40 in peripheral device 14 of the system 10 of FIG. 1. FIG. 3 is a block diagram view of the computer system 10 of FIG. 1 illustrating cache invalidation.

The processing core(s) 40 is configured to expose device emulation function 30 to host device 12 (block 202). The processing core(s) 40 is configured to maintain peripheral device cache 46 (block 204).

The client program being executed by the host device 12 (e.g., by VM 28) may read data from local storage 22 and/or remote storage 24 via the device emulation function 30 which communicates with backend function (client) 52 and optionally backend function 54 to retrieve stored data. The read data may be cached by processing core(s) 40 in peripheral device cache 46, and by processor 16 in host cache 20. If another VM running on host device 12 or another host device writes to the same data, the backend function 52 and/or the backend function 54 (depending on where the data is stored) will generate a cache invalidation 60. When the cache invalidation 60 is generated by backend function 54, backend function 54 is configured to provide (arrow 62) the cache invalidation 60 over network 50 to NIC 44 which provides (arrow 64) the cache invalidation 60 to backend function client 52 running on processing core(s) 40. The backend function (client) 52 provides (arrow 66) the cache invalidation 60 to translation function 58. The invalidation process is now described in more detail.

The processing core(s) 40 is configured to receive cache invalidation 60 (or a command to invalidate a cache entry) from backend function (client) 52 (block 206). The processing core(s) 40 is configured to invalidate (symbol 70) a cache entry 72 in peripheral device cache 46 in response to receiving cache invalidation 60 from backend function 54 or cache invalidation 60 or the command from backend function (client) 52 (block 208).

The processing core(s) 40 is configured to execute translation function 58 to translate between a format of the device emulation function 30 and a format of the backend function 52, 54 (block 210). The step of block 210 may include the translation function 58 being configured to: receive (arrow 66) the cache invalidation 60 from the backend function 52, 54 (block 212); and translate the cache invalidation 60 to the format of the device emulation function 30 (block 214) yielding a translated cache invalidation 68.

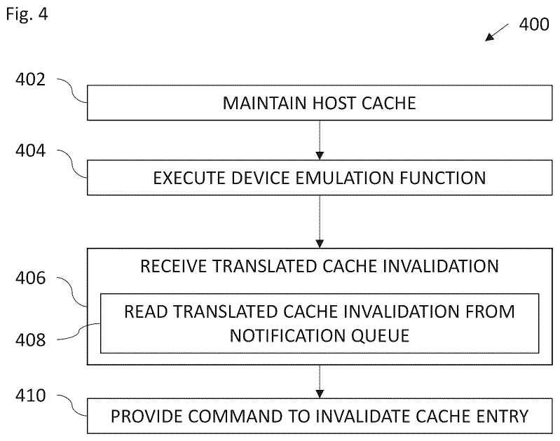

The translation function 58 is configured to provide the translated cache invalidation 68 via host interface 38 to the device emulation function 34 (which could be running on VM 28 or on processor 16 without VM 28, i.e., “bare metal”) (block 216 and arrows 74). In some embodiments, the translation function 58 is configured to provide the translated cache invalidation 68 to notification queue 36 disposed on the host device 12 (block 218). The device emulation function 34 then retrieves the translated cache invalidation 68 from notification queue 36, as described in more detail with reference to FIG. 4.

In some embodiments, the device emulation function 30 is a file system device emulation function, the backend function 52, 54 is a file system, and the translation function is configured to translate between a format of the file system device emulation function and a format of the file system. The file system may be a local file system, which is executed by the peripheral device 14. Additionally, or alternatively, the file system may be a remote file system, which is executed by remote server 56.

In some embodiments, the device emulation function 30 is a block storage system device emulation function, the backend function is a block storage system, and the translation function is configured to translate between a format of the block storage system device emulation function and a format of the block storage system.

Reference is now made to FIG. 4, which is a flowchart 400 including steps in a method of operation of processor 16 of host device 12 of the system 10 of FIG. 1. Reference is also made to FIG. 3. The processor 16 is configured to maintain host cache 20 (block 402) and execute the device emulation function 30, 32, 34 (block 404). The device emulation function 34 is configured to receive the translated cache invalidation 68 (block 406). In some embodiments, the device emulation function 34 is configured to read the translated cache invalidation 68 from the notification queue 36 (block 408). The device emulation function 34 is configured to generate and provide a command (e.g., to VM 28 or processor 16) to invalidate a cache entry 78 in the host cache 20 based on the received translated cache invalidation (block 410). The VM 28 or the processor 16 is configured to invalidate (symbol 76) cache entry 78 in host cache 20. The device emulation function 34 may receive an acknowledgement of the cache invalidation from processor 16 and provide an acknowledgement of the cache invalidation to the backend function (client) 52 and/or backend function 54, via translation function 58.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

1. A device, comprising: a host interface to be connected to a host device via a data communication bus; and at least one processing core to:
expose a device emulation function to the host device;
maintain a peripheral device cache;
invalidate a cache entry in the peripheral device cache in response to receiving a cache invalidation from a backend function; and
execute a translation function to:
translate between a format of the device emulation function and a format of the backend function;
receive the cache invalidation from the backend function;
translate the received cache invalidation to the format of the device emulation function yielding a translated cache invalidation; and
provide the translated cache invalidation to the device emulation function being executed by a processor of the host device.

2. The device according to claim 1, wherein:
the device emulation function is a file system device emulation function;
the backend function is a file system; and
the translation function is to translate between a format of the file system device emulation function and a format of the file system.

3. The device according to claim 2, wherein the file system is a local file system, and is executed by the peripheral device.

4. The device according to claim 1, wherein:
the device emulation function is a block storage system device emulation function;
the backend function is a block storage system; and
the translation function is to translate between a format of the block storage system device emulation function and a format of the block storage system.

5. The device according to claim 1, wherein the translation function is to provide the translated cache invalidation to a notification queue disposed on the host device.

6. The device according to claim 1, further comprising a data processing unit (DPU) including the at least one processing core and a network interface controller (NIC).

7. A system, comprising a host device and a peripheral device, the host device including a processor, the peripheral device including: a host interface to be connected to a host device via a data communication bus; and at least one processing core to:
expose a device emulation function to the host device;
maintain a peripheral device cache; and
invalidate a cache entry in the peripheral device cache in response to receiving a cache invalidation from a backend function; and
execute a translation function to:
translate between a format of the device emulation function and a format of the backend function;
receive the cache invalidation from the backend function;
translate the received cache invalidation to the format of the device emulation function yielding a translated cache invalidation; and
provide the translated cache invalidation to the device emulation function being executed by the processor of the host device.

8. The system according to claim 7, wherein:
the device emulation function is a file system device emulation function;
the backend function is a file system; and
the translation function is to translate between a format of the file system device emulation function and a format of the file system.

9. The system according to claim 8, wherein the file system is a local file system, and is executed by the peripheral device.

10. The system according to claim 7, wherein:
the device emulation function is a block storage system device emulation function;
the backend function is a block storage system; and
the translation function is to translate between a format of the block storage system device emulation function and a format of the block storage system.

11. The system according to claim 7, wherein:
the processor is to execute the device emulation function;
the processor is to maintain a host cache; and
the device emulation function is to receive the translated cache invalidation and provide a command to invalidate a cache entry in the host cache based on the received translated cache invalidation.

12. The system according to claim 11, wherein the translation function is to provide the translated cache invalidation to a notification queue disposed on the host device, and the device emulation function is to read the translated cache invalidation from the notification queue.

13. The system according to claim 11, wherein:
the processor of the host device is to execute a hypervisor; and
the hypervisor is to execute a virtual machine (VM), which is to execute the device emulation function.

14. The system according to claim 11, wherein:
the device emulation function is a file system device emulation function;
the backend function is a file system; and
the translation function is to translate between a format of the file system device emulation function and a format of the file system.

15. The system according to claim 7, wherein the peripheral device includes a data processing unit (DPU), including the at least one processing core and a network interface controller (NIC).

16. A method, comprising:
exposing a device emulation function to a host device;
maintaining a peripheral device cache;
invalidating a cache entry in the peripheral device cache in response to receiving a cache invalidation from a backend function;
translating between a format of the device emulation function and a format of the backend function;
receiving the cache invalidation from the backend function;
translating the received cache invalidation to the format of the device emulation function yielding a translated cache invalidation; and
providing the translated cache invalidation to the device emulation function being executed by a processor of the host device.

17. The method according to claim 16, wherein:
the device emulation function is a file system device emulation function;
the backend function is a file system; and
the method further comprises translating between a format of the file system device emulation function and a format of the file system.

18. The method according to claim 16, wherein:
the device emulation function is a block storage system device emulation function;
the backend function is a block storage system; and
the method further comprises translating between a format of the block storage system device emulation function and a format of the block storage system.

19. The method according to claim 16, further comprising:
executing the device emulation function in the host device;
maintaining a host cache;
receiving the translated cache invalidation; and
providing a command to invalidate a cache entry in the host cache based on the received translated cache invalidation.

20. The method according to claim 19, further comprising:
providing the translated cache invalidation to a notification queue disposed on the host device; and
reading the translated cache invalidation from the notification queue.
